(19) United States
(12) Patent Application Publication
(10) Pub. No.: US 2023/0140365 A1
(43) Pub. Date: May 4, 2023

(54) AUTOMATED CIRCUIT TOPOLOGY SELECTION AND CONFIGURATION

(71) Applicant: The Regents of the University of Michigan, Ann Arbor, MI (US)

(72) Inventors: Wencong SU, Troy, MI (US); Yi Lu MURPHEY, Ann Arbor, MI (US); Mengqi WANG, Troy, MI (US); Can HUANG, Fremont, CA (US); Ruben GLATT, Livermore, CA (US)

(21) Appl. No.: 17/978,935

(22) Filed: Nov. 1, 2022

Related U.S. Application Data
(60) Provisional application No. 63/274,290, filed on Nov. 1, 2021.

(51) Int. Cl. G06F 30/27; G06F 30/392

(52) U.S. Cl. CPC G06F 30/27; G06F 30/392

(57) ABSTRACT

A system and method for automatically determining a topology configuration for a power converter. The system is configured to perform a method that includes the steps of: receiving, at a workstation, one or more design attributes from a user; automatically selecting a topology through use of a machine learning (ML) technique that takes, as input, the received design attribute(s); determining one or more design parameter values for one or more design parameters to be used along with the automatically selected topology; and providing the automatically selected topology and determined design parameter value(s) to the user.

### GOVERNMENT FUNDING

This invention was made with government support under DE-AR0001219 awarded by the Department of Energy. The government has certain rights in the invention.

### TECHNICAL FIELD

This disclosure relates to methods and systems for selecting a circuit topology and determining configuration parameters or properties therefor.

### BACKGROUND

When developing circuitry for a power converter, engineers may consider a wide range of different architectures or topologies and the particular configuration of the circuitry may be determined based on desired operating parameters, such as certain input and output specifications. Moreover, while computer systems can evaluate or simulate circuitry to provide users with information on expected or anticipated performance, such simulations are resource-intensive. Accordingly, because the number of possible circuitry configurations is vast, determining a proper circuitry configuration for a given set of operating parameters becomes a very large problem in terms of resources.

### SUMMARY

In accordance with an aspect of the disclosure, there is provided a method of automatically determining a topology configuration for a power converter. The method includes the steps of: receiving, at a workstation, one or more design attributes from a user; automatically selecting a topology through use of a machine learning (ML) technique that takes, as input, the received design attribute(s); determining one or more design parameter values for one or more design parameters to be used along with the automatically selected topology; and providing the automatically selected topology and determined design parameter value(s) to the user.

According to various embodiments, this method may further include any one of the following features or any technically-feasible combination of some or all of these features:
the step of automatically selecting a topology includes automatically selecting a plurality of topologies that includes the automatically selected topology;
each of the plurality of automatically selected topologies are presented at the workstation and to the user, and wherein the workstation is configured to allow the user to choose one of the plurality of automatically selected topologies as the automatically selected topology;
the step of determining one or more design parameter values for one or more design parameters is carried out for each of the plurality of automatically selected topologies;
the ML technique is a decision tree technique in which the received design attribute(s) are used as input into a decision tree;
the decision tree is trained with training data using decision tree learning, and wherein the training data is obtained from one or more electronic data sources that are remote to the workstation;
the step of determining one or more design parameter values for one or more design parameters includes using a reinforcement learning (RL) technique;
the step of determining one or more design parameter values for one or more design parameters includes using the RL technique in combination with a simulation model;
the simulation model is a surrogate model that models a physics-based simulation; and/or
the surrogate model is implemented at least in part by a neural network.

In accordance with another aspect of the disclosure, there is provided an automated topology determination system, comprising one or more electronic processors and non-transitory, computer-readable memory that is accessible by the one or more electronic processors and that stores computer instructions. When the computer instructions are executed by the one or more electronic processors, the automated topology determination system: receives, at a workstation, one or more design attributes from a user; automatically selects a topology through use of a machine learning (ML) technique that takes, as input, the received design attribute(s); determines one or more design parameter values for one or more design parameters to be used along with the automatically selected topology; and provides the automatically selected topology and determined design parameter value(s) to the user.

According to various embodiments, this automated topology determination system may further include any one of the following features or any technically-feasible combination of some or all of these features:
when the computer instructions are executed by the one or more electronic processors, the automated topology determination system automatically selects a plurality of topologies that includes the automatically selected topology;
wherein each of the plurality of automatically selected topologies are presented at the workstation and to the user, and wherein the workstation is configured to allow the user to choose one of the plurality of automatically selected topologies as the automatically selected topology;
the step of determining one or more design parameter values for one or more design parameters is carried out for each of the plurality of automatically selected topologies;
the ML technique is a decision tree technique in which the received design attribute(s) are used as input into a decision tree;
the decision tree is trained with training data using decision tree learning, and wherein the training data is obtained from one or more electronic data sources that are remote to the workstation;
the step of determining one or more design parameter values for one or more design parameters includes using a reinforcement learning (RL) technique;
the step of determining one or more design parameter values for one or more design parameters includes using the RL technique in combination with a simulation model;
the simulation model is a surrogate model that models a physics-based simulation; and/or
the surrogate model is implemented at least in part by a neural network.

### BRIEF DESCRIPTION OF THE DRAWINGS

Preferred exemplary embodiments will hereinafter be described in conjunction with the appended drawings, wherein like designations denote like elements, and wherein:

FIG. 1 depicts a communications system that includes an automated topology determination system, according to one embodiment;

FIG. 2 depicts an exemplary graphical user interface (GUI) that is used to present information to a user located at the workstation of FIG. 1, according to at least one embodiment;

FIG. 3 is a flowchart of a method of automatically determining a topology configuration for a power converter, according to one embodiment;

FIG. 4 is a diagrammatic depiction of an exemplary structure of a surrogate model and block diagram of a training process, according to embodiments; and

FIG. 5 is a diagrammatic depiction of an exemplary training and testing process of a surrogate model, according to embodiments.

### DETAILED DESCRIPTION

The system and method described herein enables automated selection of a circuit topology as well as determination of design parameters for the selected circuit topology. As used herein, a “circuit topology” or simply “topology” refers to a particular or specified configuration or arrangement of electronic circuit components, such as inductors, capacitors, transistors, diodes, etc. In some embodiments, the system and method are used for selecting a topology for a power converter which, as will be appreciated by those skilled in the art, may be used for converting an input signal to an output signal having a specified voltage.

The automated topology determination system described herein may be configured to implement the method described herein. According to at least some embodiments, the method includes: receiving one or more design attributes from a user; automatically selecting a topology through use of a machine learning (ML) technique that takes, as input, the received design attribute(s); determining design parameter value(s) for one or more design parameters to be used along with the automatically selected topology; and providing the automatically selected topology and the determined design parameter value(s) to the user. In some embodiments, the method further includes providing estimated performance metrics, which may be calculated based on the automatically selected topology and determined design parameter value(s), to the user. The design attribute(s) may specify, for example, an input voltage, an output voltage, an output power, a power efficiency, and an isolation flag (i.e., a Boolean flag indicating whether the power converter is to isolate the input signal from the output signal by electrically and physically separating the power converter into two sections). The automatically selected topology (or topologies) may be based on or derived from a predetermined set of topologies, which, when used for automatically selecting a topology for a power converter, may include a buck topology, a boost topology, a buck-boost topology, a forward topology, a dual switch forward topology, a push-pull topology, a half bridge topology, a LLC resonant topology, a flyback topology, a full bridge topology, and a dual active bridge topology.

As used herein, “technique” refers to any of a number of specific types of processes. Various ML techniques may be used, including decision tree, neural network, advanced regression model, or genetic algorithm techniques. According to at least some embodiments, the ML technique used for automatically selecting the topology is a decision tree technique which utilizes a decision tree that is generated through a decision tree learning process. In such embodiments, the use of a decision tree enables certain users, such as power converter designers, to more readily understand the underlying topology selection process even when such users are not particularly skilled in machine learning—i.e., in some scenarios, the use of a decision tree as the ML technique instead of, for example, the aforementioned neural network, advanced regression model, or genetic algorithm techniques, allows an individual that is not particularly skilled in ML to understand the underlying topology selection process as the decision tree may be broken down into more understandable decision steps.

According to at least some embodiments, the step of determining design parameter value(s), which may be optimal design parameter value(s), includes using a reinforcement learning (RL) technique. In particular, the RL technique may be used to determine the design parameter value(s) based on using the selected topology and the received design attribute(s) in connection with one or more simulation models. The simulation model(s), which are computer simulation model(s), may be used to determine performance (e.g., an efficiency, such as a power efficiency) of the selected topology when configured according to the received design attribute(s) and design parameter value(s). The design parameter value(s) may thus be evaluated to determine the performance, which may be represented by one or more performance metrics, and, through use of the RL technique, may be used to determine improved or desirable design parameter value(s) for the automatically selected topology and the received design attribute(s). In one embodiment, the simulation model is a physics-based model and, in another embodiment, the simulation model is a surrogate model that models a physics-based simulation, such as a Simulink™ simulation. At least in some embodiments, the surrogate model is, includes, or implements a ML-based model, such as a deep neural network (DNN). In one embodiment, a DNN is trained using simulation training data that is collected as a result of performing simulations with differing inputs and capturing the output of the simulations, which may be Simulink™ simulations. The surrogate model, thus, provides a mechanism for evaluating or determining the power efficiency or other performance metric for a particular set of inputs, which include a topology, design attribute(s), and design parameter value(s). The surrogate model may be used to evaluate and/or determine design parameter value(s) without having to actually perform a simulation, which may reduce the time it takes to evaluate/determine design parameter value(s) and/or determine the performance.

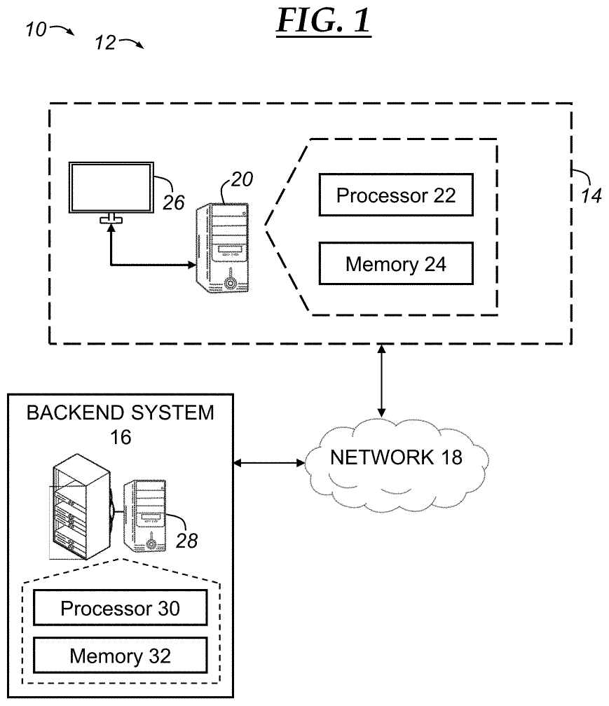

With reference now to FIG. 1, there is shown a communications system 10 that includes an automated topology determination system 12, a workstation 14, a backend system 16, and a communications network 18 that provides data connectivity between the workstation 14 and the backend system 16. It should be appreciated that while the illustrated embodiment of FIG. 1 provides an example of one communications system 10, the automated topology determination system 12 and method described below may be used as part of various other communications systems.

The workstation 14 is illustrated as including a computer 20 having a processor 22 and memory 24. Although the workstation 14 is illustrated and described as including a desktop computer as the computer 20, in other embodiments, the workstation 14 may include another type of computer, such as a laptop, in lieu of or in addition to the desktop computer. The workstation 14 also includes an electronic display 26 that is connected to the computer 20 and the workstation 14 is configured so that the electronic display 26 may display certain graphics, data, or other information stored at or made available to or by the computer 20. In one embodiment, the electronic display 26 is a liquid crystal display (LCD); however, it should be appreciated that other types of electronic displays may be used. Also, in one embodiment, the electronic display 26 is a touchscreen that is capable of receiving input from a user and providing the input to the computer 20. According to various embodiments, the workstation 14 may include other computer peripherals, such as keyboard(s), a computer mouse, speaker(s), camera(s), microphone(s), etc. The workstation 14 is illustrated as being connected to the communications network 18 and, accordingly, may include suitable network adapters or devices for carrying out electronic data communications over the communications network 18, such as for purposes of sending information to and/or receiving information from the backend system 16. Although only a single workstation 14 is shown and described, it should be appreciated that the system 12 may include a plurality of workstations and, with respect to such embodiments, the discussion of the workstation 14 applies equally to each of the plurality of workstations.

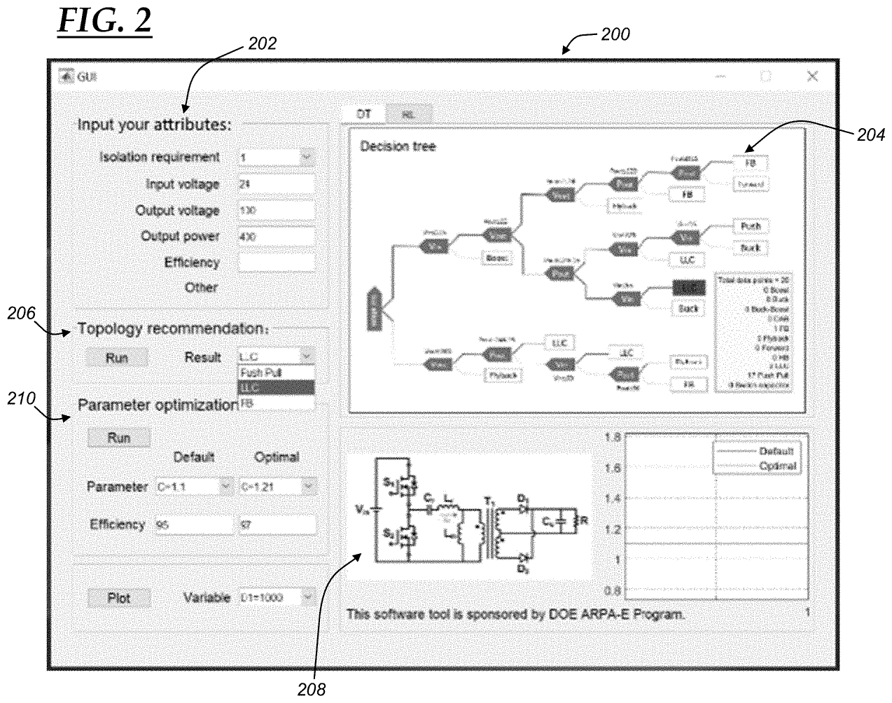

With reference to FIG. 2, there is shown an exemplary graphical user interface (GUI) 200 that is used to present information to a user located at the workstation 14, according to at least one embodiment. The GUI 200 may be used by the user to provide input into the automated topology determination system 12 and to provide output of the automated topology determination system 12 to the user. The GUI 200 may be presented on the electronic display 26 of the workstation 14 and may be operable using one or more computer peripherals, such as a keyboard, mouse, touchscreen, microphone, etc. The GUI 200 includes a first graphical portion or design attribute input portion 202 that is usable by the user for inputting one or more design attributes into the GUI 200. In the exemplary embodiment depicted in FIG. 2, the design attribute input portion 202 includes a plurality of input objects, including an isolation requirement input object (shown in FIG. 2 as having an input value of “1”), an input voltage input object (shown in FIG. 2 as having an input value of “24”), an output voltage input object (shown in FIG. 2 as having an input value of “100”), an output power input object (shown in FIG. 2 as having an input value of “400”), and an efficiency input object (shown in FIG. 2 as having no input value). It should be appreciated that the design attribute input portion 202 may include other input object(s) for purposes of specifying values of other design attribute(s).

The GUI 200 also includes a second graphical portion or decision tree (DT) portion 204 that provides a graphical representation of the decision tree that is used as a part of selecting a topology. This graphical representation (shown at 204) is depicted as a binary tree that includes various decision blocks that may be used for purposes of mapping the input or design attributes to a topology. Once a step of automatically selecting a topology is performed, the DT portion 204 may include graphics highlighting the path taken from the root node (i.e., the start block, located toward the left side of the DT portion 204) to the leaf node, which may specify the one or more automatically selected topologies.

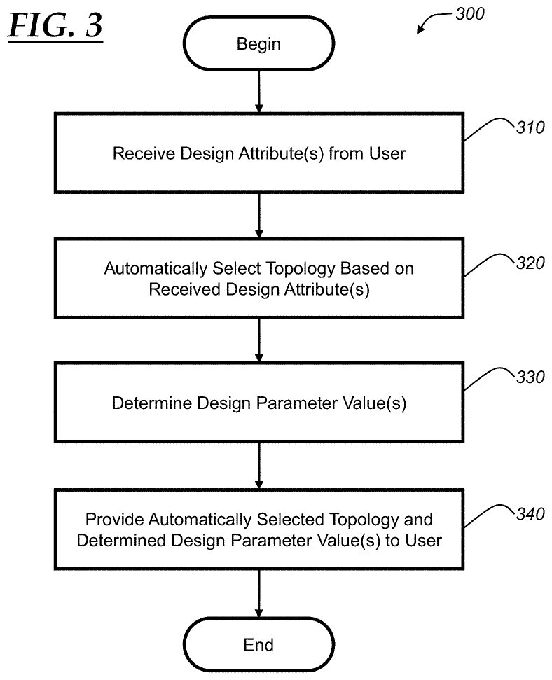

The GUI 200 also includes a third graphical portion or topology selection portion 206 that provides an indication of one or more automatically selected topologies that were automatically selected based on the inputted design attribute(s) and the decision tree. The topology selection portion 206 may thus be used to provide the one or more automatically selected topologies to the user. In the depicted embodiment of FIG. 2, the topology selection portion 206 specifies three selected topologies: “Push Pull”, “LLC”, and “FB”. These automatically selected or recommended topologies may be automatically populated by the GUI 200 in response to the user selecting the “Run” button that is located in the topology selection portion 206—i.e., once the user inputs the design attribute(s) into the design attribute input portion 202 and then clicks/activates the “Run” button of the topology selection portion 206, the system 12 generates an output that specifies one or more automatically selected topologies, such as that which is described below as a part of the method 300 (FIG. 3). In response to running such a process, the DT portion 204 may highlight the path taken from the root node to the leaf node thereby apprising the user of the underlying decisions made as a part of automatically selecting the topology. A drop down menu, which is shown in FIG. 2 as a part of the topology selection portion 206, is then populated with the one or more automatically selected topologies.

The GUI 200 also includes a fourth graphical portion or topology circuit view portion 208, which provides graphics illustrating a circuit schematic of one of the automatically selected topologies. The topology that is depicted in the topology circuit view portion 208 may be changed by the user through the user choosing one of the automatically selected topologies in the drop down menu of the topology selection portion 206.

The GUI 200 also includes a fifth graphical portion or parameter optimization portion 210. It should be appreciated that the term “optimization” (or its other various forms), as that term is used in connection with design parameters values, refers to improving the design parameter values. The parameter optimization portion 210 includes a “Run” button that, when clicked/activated, causes a parameter optimization or determination process to be carried out in which one or more design parameter values are determined. In one embodiment, the design parameter value(s) are determined based on the automatically selected topology that is chosen from the drop down menu of the topology selection portion 206. The user may change the chosen topology by using the drop down menu of the topology selection portion 206, which lists all of the automatically selected topologies—as mentioned above, in the depicted embodiment, there are three automatically selected topologies, one of which is chosen (the “LLC” topology). The design parameter value(s) are populated in the drop down menu of the parameter optimization portion 210 that is located under the column header “Optimal”. Default values for each design parameter value(s) may also be loaded or populated into a drop down menu of the parameter optimization portion 210, which is shown in FIG. 2 as being located under the column header “Default”. The default or initial design parameter value(s) may be predetermined for each topology of the predetermined set of topologies. For example, in one embodiment, there are eleven predetermined topologies included in the predetermined set of topologies, any number of which may be automatically selected or recommended to the user. Each of these eleven predetermined topologies may be associated with one or more default or initial design parameter values.

With reference back to FIG. 1, according to at least some embodiments, the workstation 14 is used for carrying out one or more steps of the method described herein, such as one or more steps of the method 300 (FIG. 3) described below. In particular, for example, the workstation 14 may be used for receiving one or more design attributes from the user and/or for providing the automatically selected topology and determined design parameter value(s) to the user, which is discussed in more detail below. In at least one embodiment, the workstation 14 may be configured to perform the method 300, including all the steps described therein. In other embodiments, certain steps of the method, such as the step of automatically selecting a topology and the step of determining design parameter value(s) for one or more design parameters to be used along with the automatically selected topology, may be carried out by the backend system 16.

The backend system 16 is a computer system that includes at least one computer 28 having a processor 30 and memory 32. In one embodiment, the backend system 16 may operate as a server for providing certain backend functionality to the workstation 14, such as for providing data used as a part of the method 300 (FIG. 3), carrying out one or more steps of the method 300, and/or otherwise providing services or support for the GUI 200 and/or other features of the workstation 14. Although only a single computer 28 is shown and described, it should be appreciated that the backend system 16 may include a plurality of computers and, with respect to such embodiments, the discussion of the computer 28 applies equally to each of the plurality of computers. The backend system 16 may be used for various purposes and, in one embodiment, is used for carrying out one or more steps of the method described herein, such as one or more steps of the method 300 described below. In particular, for example, the backend system 16 may be used for automatically selecting a topology and determining design parameter value(s) for one or more design parameters to be used along with the automatically selected topology.

The communications network 18 is an electronic data communications network and may be implemented using a variety of different technologies according to the needs and/or desires in which the automated topology determination system 12 is used. For example, in one embodiment, the communications network 18 is a local area network (LAN), which may be implemented as a wireless LAN (WLAN) having one or more wireless routers that carry out Wi-Fi™ communications. In another embodiment, the communications network 18 provides for remote data connectivity, such as that which is provided by an internet service provider (ISP) and used to connect to the internet. The communications network 18 may be implemented through use of a public switched telephone network (PSTN), a wireless carrier system or network (e.g., those providing for a cellular-based network), etc. In one embodiment, one or more components of the workstation 14 (e.g., the computer 20) and one or more components of the backend system 16 (e.g., the computer 28) may be connected directly in a peer-to-peer manner, such as through the user of Bluetooth™ and, in such embodiments, a separate communications network 18 may be omitted.

The automated topology determination system 12 includes one or more processors and memory accessible by the one or more processors. The memory may be implemented by one or more memory devices that may or may not be co-located. The memory stores computer instructions that, when executed, cause the method described herein, such as the method 300 (FIG. 3), to be carried out. The one or more processors of the automated topology determination system 12 may include the processor 22 of the workstation 14, the processor 30 of the backend system 16, and/or one or more other processors. The memory of the automated topology determination system 12 may include the memory 24 of the workstation 14, the memory 32 of the backend system 16, and/or one or more other memory devices.

Any one or more of the processors (e.g., the processor 22, the processor 30) discussed herein is an electronic processor and may be implemented as any suitable electronic hardware that is capable of processing computer instructions. Any one or more of the processors may be selected based on the application in which it is to be used. Examples of types of processors that may be used include central processing units (CPUs), graphics processing units (GPUs), field-programmable gate arrays (FPGAs), application specific integrated circuits (ASICs), microprocessors, microcontrollers, etc. Any of the memory (e.g., the memory 24, the memory 32) discussed herein may be implemented as any suitable type of non-transitory, computer-readable memory that is capable of storing data or information in a non-volatile manner and in an electronic form so that the stored data or information is consumable by an electronic processor. The memory may be any a variety of different electronic memory types and may be selected based on the application in which it is to be used. Examples of types of memory that may be used include magnetic or optical disc drives, ROM (read-only memory), solid-state drives (SSDs) (including other solid-state storage such as solid state hybrid drives (SSHDs)), other types of flash memory, hard disk drives (HDDs), non-volatile random access memory (NVRAM), etc. It should be appreciated that any one or more of the computers discussed herein may include other memory, such as volatile RAM that is used by the processor, and/or multiple processors.

With reference to FIG. 3, there is shown an embodiment of a method 300 of automatically determining a topology configuration for a power converter. At least according to some embodiments, the method 300 is performed by the automated topology determination system 12. The method 300 begins with step 310, wherein one or more design attributes are received from a user. In at least one embodiment, the design attribute(s) are received at the workstation 14, such as through the user inputting the design attributes into a GUI provided by the workstation 14, such as the GUI 200 (FIG. 2) discussed above. The user may use one or more computer peripherals, such as a keyboard and mouse, to input the design attribute(s). In other embodiments, the design attribute(s) may be loaded into the automated topology determination system 12 in another manner, such as from a computer file that may be specified by a user or as a result of an automatic process, for example. The method 300 continues to step 320.

In step 320, a topology is automatically selected through use of a machine learning (ML) technique that takes, as input, the received design attribute(s). In one embodiment, this step 320 is carried out by the workstation 14, such as by the computer 20. In another embodiment, this step 320 is carried out by the backend system 16, such as by the computer 28. In yet another embodiment, this step 320 is carried out, in part, by the workstation 14 and, in part, by the backend system 16. In one embodiment, this step 320 is carried out in response to receiving a request to select or recommend a topology from the user of the workstation 14, which may be the result of the user selecting the “Run” button in the topology selection portion 206 of the GUI 200 (FIG. 2). This step includes “automatically” selecting a topology, which, as used herein, means that a topology is selected in an automated fashion as a result of computer instructions being executed.

In at least one embodiment, the ML technique is a decision tree technique in which a decision tree is generated as a result of a decision tree learning process. In other embodiments, one or more other ML techniques may be used as a part of automatically selecting the topology. The decision tree learning process is a ML training process in which a decision tree is learned or improved based on carrying out decision tree learning using training data. In one embodiment, the training data is obtained from one or more third party sources, such as from online catalogs (e.g., Digikey™), design tutorials from electronics vendors, and technical papers and articles. In at least one embodiment, the training data is obtained from one or more electronic data sources that are remote to the workstation 14 and backend system 16. For example, one or more remote servers may host training data and this training data may be downloaded to the workstation 14 or the backend system 16 via a remote data connection, such as one established through use of the internet.

The decision tree may be implemented using a classification and regression tree (CART) technique in which each node has two edges or branches—i.e., each decision has two possible outcomes. The leaf nodes each specify one or more topology classes that are selected and, in one embodiment, one or more leaf nodes may each specify two or more topology classes; in other embodiments, one or more leaf nodes may each specify only one topology class. According to at least some embodiments and implementations, using a decision tree technique as the ML technique in this step has the following advantages: it is non-parametric; it allows both discrete and continuous inputs and outputs; it can provide reasonable predictions even with missing data, which may be important if the automated topology determination system 12 is to be implemented with or in commercial tools; it can be easily and/or readily understood by design engineers or other users that are not specialized in ML; and, as shown in FIG. 2 at the decision tree portion 204, the decision tree can be easily visualized and graphed so that it is easy for a user to track and see the basis for the topology selection(s). As mentioned above, the path from the root node to the leaf node having the automatically selected topology or topologies may be highlighted using graphics, such as graphics that thicken or color the edges and/or nodes representing the path, as a part of the decision tree portion 204.

The decision tree includes various decision blocks/steps that are used to map the inputs (or the received design attribute(s)) to an output or a selected topology. Each decision step may inquire into the values of one or more of the received design attribute(s), such as whether the output voltage is greater than or equal to 100V, for example. The decision blocks/steps of the decision tree may be automatically resolved by the automated topology determination system 12 based on the received design attribute(s) and, once a leaf node is reached, the topology or topologies associated with that leaf node may be selected as the selected topology or topologies. The method 300 continues to step 330.

In step 330, one or more design parameter values for one or more design parameters to be used along with the selected topology are determined. The one or more design parameters may be certain parameters that may be used along with the automatically selected topology for purposes of providing a topology configuration that specifies circuitry and a configuration thereof and that provides the desired properties or design attribute(s). The design parameter(s) may each be represented by one or more values. These design parameter value(s), when combined with the automatically selected topology, are considered a topology configuration, and this topology configuration may be provided to the user. The topology configuration may, for example, specify the automatically selected topology and values for certain design parameters used for that topology, which may be used by a design engineer or other user as part of preparing or configuring circuitry for a power converter that satisfies all (or at least some) of the received design attribute(s). Each design parameter may have or be associated with one or more design parameter values that specifies value(s) to be used for the associated design parameter. For example, a design parameter may be the capacitance of a particular capacitor that is to be used as a part of the automatically selected topology and, as an example, the associated design parameter value may be 0.02 mF.

In one embodiment, this step 330 is carried out by the workstation 14 and, specifically, by the computer 20. In another embodiment, this step 330 is carried out by the backend system 16, such as by the computer 28. In yet another embodiment, this step 330 is carried out, in part, by the workstation 14 and, in part, by the backend system 16. In one embodiment, this step 330 is carried out in response to receiving a request to improve or determine design parameter values from a user of the workstation 14, which may be the result of the user selecting the “Run” button in the parameter optimization portion 210 of the GUI 200 (FIG. 2). As mentioned above, the user of the workstation 14 may choose one of the selected topologies using the drop down menu of the topology selection portion 206 of the GUI 200 (FIG. 2). This chosen topology may then be used as the selected topology for this step as a part of determining the design parameter value(s). In some embodiments, design parameter value(s) may be determined for each of the selected topologies.

In one embodiment, a reinforcement learning (RL) technique, which is an example of a machine learning (ML) technique, is used in conjunction with a simulation model to determine the design parameter value(s); in other embodiments, other ML techniques may be used. In some embodiments, in addition to determining the design parameter value(s), the RL technique is used to determine the performance, which may be measured by power efficiency, of the automatically selected topology or topologies. Various different optimization techniques may be used, such as Q-learning and deep deterministic policy gradient (DDPG). In other embodiments, other optimization techniques may be used, such as a brute force technique. For any finite Markov decision process (FMDP), Q-learning finds an optimal policy in the sense of maximizing the expected value of the total reward (e.g., a performance metric, such as power efficiency) over all successive steps, starting from the current state, which may initially be specified at least in part by default or initial design parameter value(s) and that, as subsequent iterations are carried out, may be specified at least in part by updated or improved design parameter value(s) that may be determined as a result and/or based on previous iterations. DDPG is an off-policy deep reinforcement learning (DRL) algorithm aimed at learning dynamics in continuous state and action spaces.

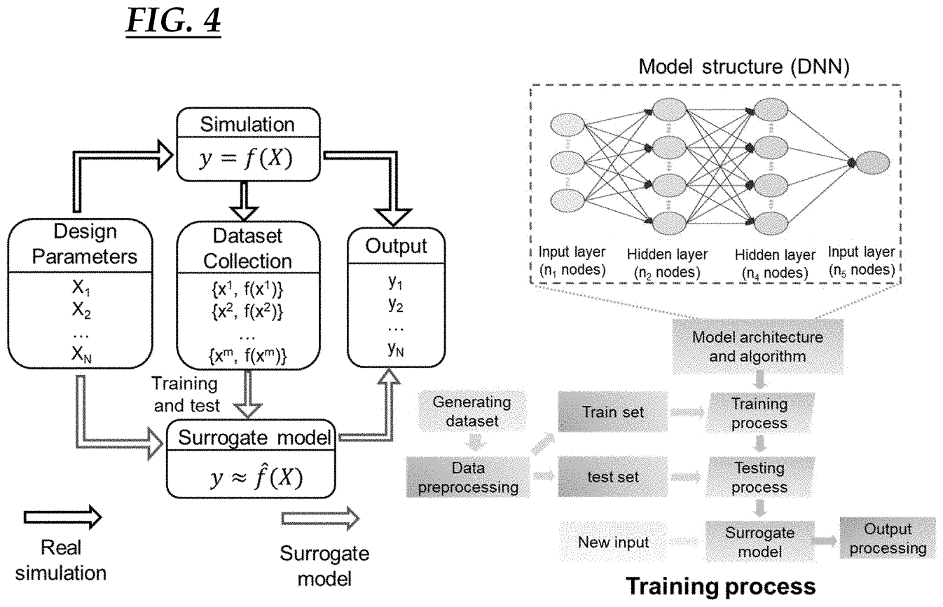

During the training process, the learning agent often interacts directly with the dynamic environment by running a simulation (e.g., a Simulink™ simulation) and a single simulation may take anywhere from several seconds to tens of seconds, at least according to some implementations and scenarios. Therefore, the training time of the RL/DRL-based algorithm/technique may be likely to last for a very long time. To reduce the training time for these models, a surrogate model for each Simulink™ model of the power converter may be used as the simulation model. The surrogate model may be implemented using a deep neural network (DNN), which is trained to mimic or imitate the behavior of the simulation, which may be a Simulink™ simulation. The overall structure of the surrogate model and block diagram of the training process is demonstrated in FIG. 4. In at least some embodiments, there are two main steps to develop the surrogate model, which are discussed below.

In the first step, a dataset is collected by running a simulation, such as through use of Simulink™, with different input data to measure the output efficiency. The simulation may be used to model the automatically selected topology when used with particular design parameter value(s). The input data includes one or more values for one or more design parameters, such as switching frequency, inductance, capacitance, input voltage, output voltage, output power, and other parameters related to MOSFET (resistance, diode voltage, rising and falling times). Initially, the value(s) used for the design parameter(s) may be initial or default design parameter value(s), which may be predetermined and/or associated with the automatically selected topology—i.e., each of the topologies of the predetermined set of topologies may be associated with initial or default design parameter value(s).

In the second step, the dataset is used to train a deep neural network (DNN) of the surrogate model. After training and testing the performance of DNN, for example, the output efficiency of a power converter having the automatically selected topology is estimated for any given input data (e.g., the initial or default design parameter value(s) in a first iteration, updated design parameter value(s) in a second or subsequent iteration) using the surrogate model instead of actually running a Simulink™ simulation or other simulation. As mentioned above, as a part of a first iteration, the initial or default design parameter value(s) may be used as the input data. In subsequent iterations, updated or modified design parameter value(s) may be used as the input data. After one or more iterations, value(s) for the design parameter(s) may be determined as the design parameter value(s) that are to be provided to the user (step 340).

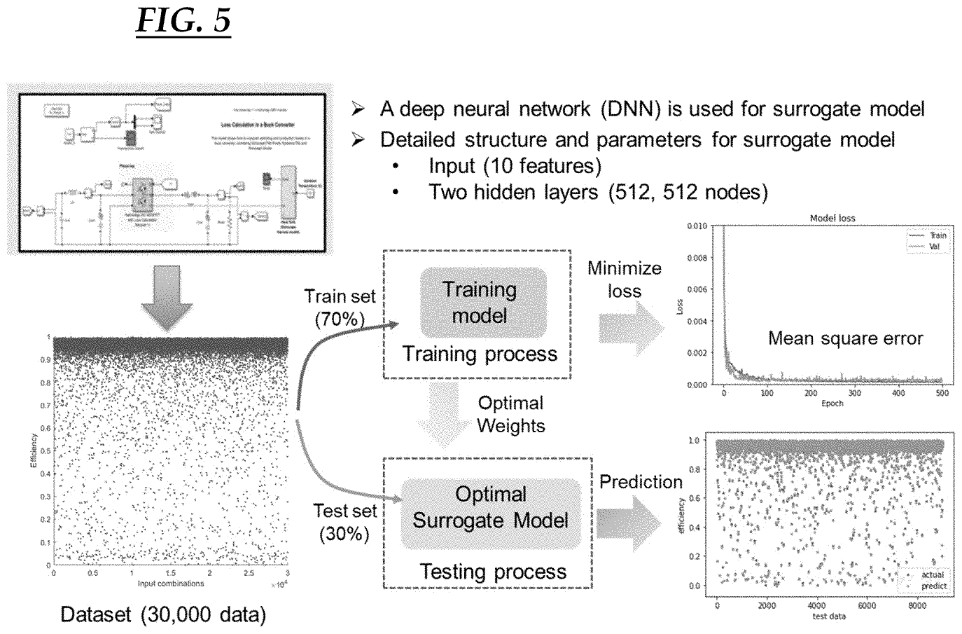

An example of a training and testing process of a surrogate model is shown in FIG. 5. As part of this example, the dataset was collected by running the Simulink™ simulation around 30,000 times. This dataset is split into the training set (70% of the dataset) and test set (30% of the dataset). The training set was used to train a DNN having 2 hidden layers with 512 nodes to minimize the loss or mean square error. After the training process, the optimal or trained DNN may be used to predict the performance or power efficiency of a power converter. The prediction time is very fast (<1 second), at least according to some implementations and scenarios. Therefore, the total learning time of the RL/DRL-based algorithm may be significantly reduced using the above described surrogate model. The method 300 continues to step 340.

In step 340, the automatically selected topology and determined design parameter value(s) are provided to the user. As mentioned above, the user may be a user of the workstation 14, at least according to some embodiments. The automatically selected topology and determined design parameter value(s) may be provided to the user by presenting the automatically selected topology and the determined design parameter value(s) on the GUI 200 (FIG. 2), such as a part of the topology selection portion 206 and the parameter optimization portion 210, respectively. In at least some embodiments, the automatically selected topology is determined prior to determining the design parameter value(s) and, in at least one embodiment, the automatically selected topology is presented to the user prior to presenting the design parameter value(s) to the user. In some embodiments, one or more performance metrics may be provided to the user, such as via use of GUI 200, in addition to the automatically selected topology and determined design parameter value(s). The one or more performance metrics may reflect an estimated or expected performance of the automatically selected topology when used with the determined design parameter value(s). Thus, at least in some embodiments, the performance metric(s) may be based on the automatically selected topology and/or the design parameter value(s). One example of a performance metric is power efficiency (q %). The method 300 then ends.

It is to be understood that the foregoing description is of one or more embodiments of the invention. The invention is not limited to the particular embodiment(s) disclosed herein, but rather is defined solely by the claims below. Furthermore, the statements contained in the foregoing description relate to the disclosed embodiment(s) and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation. In addition, the term “and/or” is to be construed as an inclusive OR. Therefore, for example, the phrase “A, B, and/or C” is to be interpreted as covering all of the following: “A”; “B”; “C”; “A and B”; “A and C”; “B and C”; and “A, B, and C.”

1. A method of automatically determining a topology configuration for a power converter, comprising the steps of:
receiving, at a workstation, one or more design attributes from a user;
automatically selecting a topology through use of a machine learning (ML) technique that takes, as input, the received design attribute(s);
determining one or more design parameter values for one or more design parameters to be used along with the automatically selected topology; and
providing the automatically selected topology and determined design parameter value(s) to the user.

2. The method of claim 1, wherein the step of automatically selecting a topology includes automatically selecting a plurality of topologies that includes the automatically selected topology.

3. The method of claim 2, wherein each of the plurality of automatically selected topologies are presented at the workstation and to the user, and wherein the workstation is configured to allow the user to choose one of the plurality of automatically selected topologies as the automatically selected topology.

4. The method of claim 2, wherein the step of determining one or more design parameter values for one or more design parameters is carried out for each of the plurality of automatically selected topologies.

5. The method of claim 1, wherein the ML technique is a decision tree technique in which the received design attribute(s) are used as input into a decision tree.

6. The method of claim 5, wherein the decision tree is trained with training data using decision tree learning, and wherein the training data is obtained from one or more electronic data sources that are remote to the workstation.

7. The method of claim 1, wherein the step of determining one or more design parameter values for one or more design parameters includes using a reinforcement learning (RL) technique.

8. The method of claim 7, wherein the step of determining one or more design parameter values for one or more design parameters includes using the RL technique in combination with a simulation model.

9. The method of claim 8, wherein the simulation model is a surrogate model that models a physics-based simulation.

10. The method of claim 9, wherein the surrogate model is implemented at least in part by a neural network.

11. An automated topology determination system, comprising one or more electronic processors and non-transitory, computer-readable memory that is accessible by the one or more electronic processors and that stores computer instructions;
wherein, when the computer instructions are executed by the one or more electronic processors, the automated topology determination system:
receives, at a workstation, one or more design attributes from a user;
automatically selects a topology through use of a machine learning (ML) technique that takes, as input, the received design attribute(s);
determines one or more design parameter values for one or more design parameters to be used along with the automatically selected topology; and
provides the automatically selected topology and determined design parameter value(s) to the user.

12. The automated topology determination system of claim 11, wherein, when the computer instructions are executed by the one or more electronic processors, the automated topology determination system automatically selects a plurality of topologies that includes the automatically selected topology.

13. The automated topology determination system of claim 12, wherein each of the plurality of automatically selected topologies are presented at the workstation and to the user, and wherein the workstation is configured to allow the user to choose one of the plurality of automatically selected topologies as the automatically selected topology.

14. The automated topology determination system of claim 12, wherein the step of determining one or more design parameter values for one or more design parameters is carried out for each of the plurality of automatically selected topologies.

15. The automated topology determination system of claim 11, wherein the ML technique is a decision tree technique in which the received design attribute(s) are used as input into a decision tree.

16. The automated topology determination system of claim 15, wherein the decision tree is trained with training data using decision tree learning, and wherein the training data is obtained from one or more electronic data sources that are remote to the workstation.

17. The automated topology determination system of claim 11, wherein the step of determining one or more design parameter values for one or more design parameters includes using a reinforcement learning (RL) technique.

18. The automated topology determination system of claim 17, wherein the step of determining one or more design parameter values for one or more design parameters includes using the RL technique in combination with a simulation model.

19. The automated topology determination system of claim 18, wherein the simulation model is a surrogate model that models a physics-based simulation.

20. The automated topology determination system of claim 19, wherein the surrogate model is implemented at least in part by a neural network.
